(19) United States
(12) Patent Application Publication
(10) Pub. No.: US 2024/0020152 A1
(43) Pub. Date: Jan. 18, 2024

(54) METHOD FOR LOADING COMPONENT OF APPLICATION AND RELATED APPARATUS

(71) Applicant: HUAWEI TECHNOLOGIES CO., LTD., Shenzhen (CN)

(72) Inventors: Ming CHEN, Hangzhou (CN); Min WANG, Shenzhen (CN)

(21) Appl. No.: 18/476,200

(22) Filed: Sep. 27, 2023

Related U.S. Application Data
(63) Continuation of application No. PCT/CN2022/083510, filed on Mar. 28, 2022.

(30) Foreign Application Priority Data
Mar. 30, 2021 (CN) 202110343661.4

(51) Int. Cl. G06F 9/48; G06F 9/451

(52) U.S. Cl. CPC G06F 9/485; G06F 9/451

(57) ABSTRACT

The present disclosure relates to methods for loading a component of an application and apparatuses. In one example method, a user interface (UI) thread of an application is running, and all or some components of the application are loaded based on a thread running in parallel with the UI thread.

### CROSS-REFERENCE TO RELATED APPLICATIONS

This application is a continuation of International Application No. PCT/CN2022/083510 filed on Mar. 28, 2022, which claims priority to Chinese Patent Application No. 202110343661.4 filed on Mar. 30, 2021. The disclosures of the aforementioned applications are hereby incorporated by reference in their entireties.

### TECHNICAL FIELD

This application relates to the field of electronic technologies, and in particular, to a method for loading a component of an application and a related apparatus.

### BACKGROUND

In a running process, an application (APP) on an electronic device usually needs to load a component to implement a corresponding function. For example, a corresponding Activity component needs to be loaded for displaying a user interface, and even a Service component needs to be loaded in some scenarios.

However, components corresponding to the application include components that are time-consuming when loaded. When these components that are time-consuming when loaded need to be used in the running process of the application, efficiency of providing a corresponding function by the application is low due to long loading duration of these components, affecting use of a user.

### SUMMARY

To resolve technical problems, in the conventional technology, of a slow response and low efficiency of an application that are caused by serial loading of a component, this application provides the following method for loading a component and related apparatus. A technical solution provided in this application can improve efficiency of loading a component of an application, so that a response speed and response efficiency of the application are improved.

According to a first aspect, this application provides a method for loading a component of an application. The method includes: running a first thread of the application, where the first thread is a user interface UI thread of the application; and loading the component of the application based on a second thread, where the second thread runs in parallel with the first thread.

In the method in this application, all or some components related to the application are loaded in parallel with the UI thread of the application. In comparison with serial loading in the conventional technology, impact of loading duration of these components on an implementation speed of a related function of the application can be avoided, and efficiency of loading the component of the application can be improved, so that a response speed and response efficiency of the application are improved.

The method in this application may be performed by a processor or a chip of an electronic device, or may be performed by a system, an operating system, or a system layer of the electronic device.

Optionally, the second thread may be a thread newly created for loading the component. Optionally, the component includes an Activity component and/or a Service component.

Optionally, the component includes a component whose loading duration is greater than or equal to a preset duration threshold. It may be understood that the preset duration threshold may be set based on a requirement. In this implementation, the component loaded in parallel is the component whose loading duration is greater than or equal to the preset duration threshold. In comparison with serial loading of all components, a problem that waiting for loading of the Activity component is time-consuming due to an excessive quantity of components can be avoided, so that the efficiency of loading the component of the application can be further improved, and the response speed and the response efficiency of the application are improved.

When the component includes the Activity component, in some implementations, the loading the component of the application based on a second thread includes: loading, in a main process starting phase of the application by using the second thread, a class file corresponding to the Activity component; and creating an empty instance in a user interface switching phase of the application based on the class file by using a third thread, where the user interface switching phase is a phase starting from inputting a user interface switching instruction by a user.

In this implementation, different operations in an Activity component loading process are respectively executed in a plurality of phases with the UI thread of the application in parallel. In comparison with executing all operations in the Activity component loading process in a same phase, a problem of waiting for loading of the Activity component caused by an excessively short time window of the same phase can be avoided, so that the efficiency of loading the component of the application can be further improved, so that the response speed and the response efficiency of the application are improved.

In this implementation, optionally, the third thread is a thread parallel to a UE thread of the application.

In this implementation, optionally, the second thread and the third thread may be a same thread, or may be different threads. When the second thread and the third thread are different threads, in an example, the third thread may be a thread newly created for creating an instance corresponding to the component.

In this implementation, optionally, before the creating an empty instance in a user interface switching phase of the application based on the class file by using a third thread, the method further includes: receiving the user interface switching instruction input by the user in a first user interface of the application, where the user interface switching instruction instructs to switch to a second user interface, and the second user interface includes detailed information about first information described by a first control in the first user interface. After the creating an empty instance in a user interface switching phase of the application based on the class file by using a third thread, the method further includes: displaying the second user interface based on the instance.

Optionally, before the empty instance is created based on the class file by using the third thread, it is first determined whether a corresponding component has been loaded, and if the corresponding component has not been loaded, a new thread is created to load a class file corresponding to the component.

When the component includes the Service component, in some implementations, the loading the component of the application based on a second thread includes: loading the Service component in the main process starting phase of the application by using the second thread.

In this implementation, optionally, the method further includes: receiving the user interface switching instruction input by the user in a third user interface of the application, where the user interface switching instruction instructs to switch to a fourth user interface, the third user interface includes a first picture, the fourth user interface includes a second picture, the second picture and the first picture include same content, and a pixel of the second picture is higher than a pixel of the first picture; and displaying the fourth user interface based on a service corresponding to the Service component.

According to a second aspect, this application provides an apparatus for loading a component of an application. The apparatus is included in an electronic device, and the apparatus has a function of performing the method in any one of the foregoing aspect or the possible implementations of the foregoing aspect. The function may be implemented by hardware, or may be implemented by executing corresponding software by using the hardware. The hardware or the software includes one or more modules or units corresponding to the foregoing function. For example, the apparatus includes a determining module or unit and an asynchronous loading module or unit.

According to a third aspect, this application provides an electronic device, including: a display, one or more processors, a memory, a plurality of applications, and one or more computer programs. The one or more computer programs are stored in the memory. The one or more computer programs include instructions. When the instructions are executed by the electronic device, the electronic device is enabled to perform the method in any one of the foregoing aspect or the possible implementations of the foregoing aspect.

According to a fourth aspect, this application provides an apparatus for loading a component of an application, including one or more processors and one or more memories. The one or more memories are coupled to the one or more processors, the one or more memories are configured to store computer program code, the computer program code includes computer instructions, and when the one or more processors execute the computer instructions, the apparatus is enabled to perform the method in any one of the foregoing aspect or the possible implementations of the foregoing aspect.

Optionally, the apparatus may be an electronic device, or may be a chip that can be used in the electronic device.

According to a fifth aspect, this technical solution provides a computer storage medium, including computer instructions. When the computer instructions are run on an electronic device, the electronic device is enabled to perform the method in any one of the foregoing aspect or the possible implementations of the foregoing aspect.

According to a sixth aspect, this technical solution provides a computer program product. When the computer program product is run on an electronic device, the electronic device is enabled to perform the method in any one of the foregoing aspect or the possible implementations of the foregoing aspect.

### BRIEF DESCRIPTION OF DRAWINGS

FIG. 1 is a schematic diagram of a hardware structure of an electronic device according to an embodiment of this application;

FIG. 2 is a schematic diagram of a software structure of an electronic device according to an embodiment of this application;

FIG. 3 is a schematic diagram of an application scenario according to an embodiment of this application;

FIG. 4 is a schematic diagram of an application scenario according to another embodiment of this application;

FIG. 5 is a schematic flowchart of a method for loading a component according to an embodiment of this application;

FIG. 6 is a schematic flowchart of a method for loading a component according to another embodiment of this application; and

FIG. 7 is a schematic diagram of a structure of an apparatus for loading a component according to an embodiment of this application.

### DESCRIPTION OF EMBODIMENTS

An electronic device in embodiments of this application may include at least one of a mobile phone, a foldable electronic device, a tablet computer, a desktop computer, a laptop computer, a handheld computer, a notebook computer, an ultra-mobile personal computer (UMPC), a netbook, a cellular phone, a personal digital assistant (PDA), an augmented reality (AR) device, a virtual reality (VR) device, an artificial intelligence (AI) device, a wearable device, an in-vehicle device, a smart home device, or a smart city device. It should be noted that a specific type of the electronic device is not specially limited in embodiments of this application.

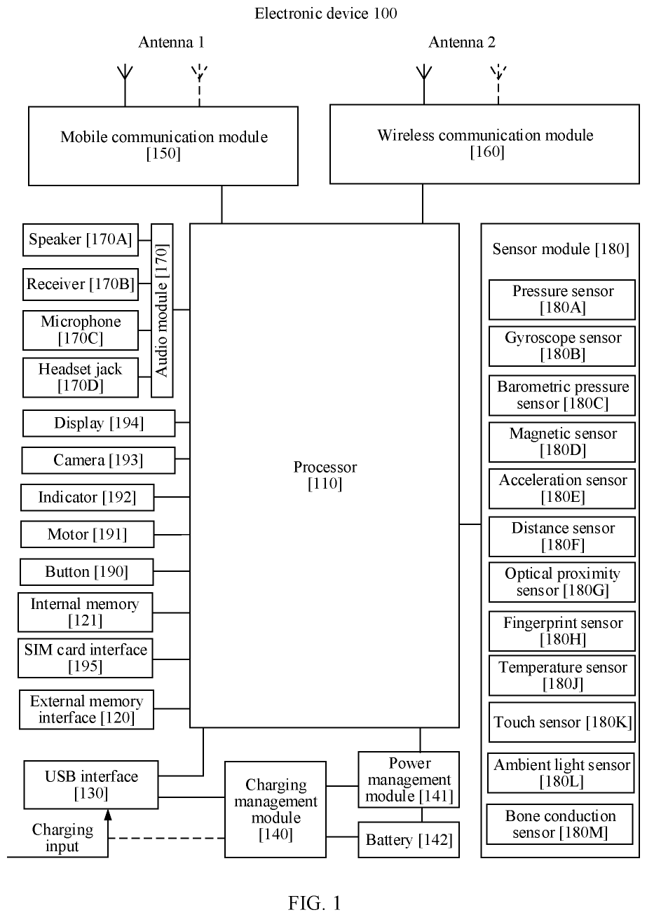

FIG. 1 is a schematic diagram of a structure of an electronic device according to an embodiment of this application. As shown in FIG. 1, the electronic device 100 may include a processor 110, an external memory interface 120, an internal memory 121, a universal serial bus (USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identity module (SIM) card interface 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It may be understood that the structure shown in this embodiment of this application does not constitute a specific limitation on the electronic device 100. In some other embodiments of this application, the electronic device 100 may include more or fewer components than those shown in the figure, or some components may be combined, or some components may be split, or different component arrangements may be used. The components shown in the figure may be implemented by hardware, software, or a combination of software and hardware.

The processor 110 may include one or more processing units. For example, the processor 110 may include an application processor (AP), a modem processor, a graphics processing unit (GPU), an image signal processor (ISP), a controller, a video codec, a digital signal processor (DSP), a baseband processor, a neural-network processing unit (NPU), and/or the like. Different processing units may be independent devices, or may be integrated into one or more processors.

The processor may generate an operation control signal based on instruction operation code and a time sequence signal to complete control of instruction reading and instruction execution.

A memory may be further set in the processor 110, and is configured to store instructions and data. In some embodiments, the memory in the processor 110 is a cache memory. The memory may store the instructions or the data that have/has been used by the processor 110 or that are/is frequently used by the processor 110. If the processor 110 needs to use the instructions or the data, the processor 110 may directly invoke the instructions or the data from the memory, to avoid repeated access and shorten a waiting time of the processor 110, so that system efficiency is improved.

In some embodiments, the processor 110 may include one or more interfaces. The interfaces may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, a universal serial bus (USB) interface, and/or the like. The processor 110 may be connected to modules such as the touch sensor, the audio module, the wireless communication module, the display, and the camera through at least one of the foregoing interfaces.

It may be understood that an interface connection relationship between the modules illustrated in embodiments of this application is merely used as an example for description, and does not constitute a limitation on the structure of the electronic device 100. In some other embodiments of this application, the electronic device 100 may alternatively use an interface connection manner different from that in the foregoing embodiment, or use a combination of a plurality of interface connection manners.

The USB interface 130 is an interface that complies with a USB standard specification, may be configured to connect the electronic device 100 to a peripheral device, and may be specifically a Mini USB interface, a Micro USB interface, a USB Type-C interface, or the like. The USB interface 130 may be configured to connect to a charger, so that the charger charges the electronic device 100; or may be configured to connect to another electronic device, so that data is transmitted between the electronic device 100 and the another electronic device. The USB interface 130 may also be configured to: connect to a headset, and output, through the headset, audio stored in the electronic device. The connector may be further configured to connect to the another electronic device such as a VR device. In some embodiments, the universal serial bus standard specification may be USB 1.x, USB 2.0, USB 3.x, and USB 4.

The charging management module 140 is configured to receive a charging input of the charger. The charger may be a wireless charger or a wired charger. In some embodiments of wired charging, the charging management module 140 may receive a charging input of the wired charger through a USB interface 130. In some embodiments of wireless charging, the charging management module 140 may receive a wireless charging input through a wireless charging coil of the electronic device 100. The charging management module 140 supplies power to the electronic device through the power management module 141 while charging the battery 142.

The power management module 141 is configured to connect to the battery 142, the charging management module 140, and the processor 110. The power management module 141 receives an input from the battery 142 and/or the charging management module 140, and supplies power to the processor 110, the internal memory 121, the display 194, the camera 193, the wireless communication module 160, and the like. The power management module 141 may be further configured to monitor parameters such as a battery capacity, a battery cycle count, and a battery health status (electric leakage or impedance). In some other embodiments, the power management module 141 may be alternatively set in the processor 110. In some other embodiments, the power management module 141 and the charging management module 140 may be alternatively set in a same device.

A wireless communication function of the electronic device 100 may be implemented through the antenna 1, the antenna 2, the mobile communication module 150, the wireless communication module 160, the modem processor, the baseband processor, and the like.

The antenna 1 and the antenna 2 are configured to transmit and receive an electromagnetic wave signal. Each antenna in the electronic device 100 may be configured to cover one or more communication frequency bands. Different antennas may be further multiplexed, to improve antenna utilization. For example, the antenna 1 may be multiplexed as a diversity antenna of a wireless local area network. In some other embodiments, the antenna may be used in combination with a tuning switch.

The mobile communication module 150 may provide a wireless communication solution that includes 2G/3G/4G/5G or the like and that is applied to the electronic device 100. The mobile communication module 150 may include at least one filter, a switch, a power amplifier, a low noise amplifier (LNA), and the like. The mobile communication module 150 may receive an electromagnetic wave through the antenna 1, perform processing such as filtering and amplifying on the received electromagnetic wave, and transmit processed electromagnetic wave to the modem processor for demodulation. The mobile communication module 150 may further amplify a signal modulated by the modem processor, and convert the signal into an electromagnetic wave for radiation through the antenna 1. In some embodiments, at least some functional modules in the mobile communication module 150 may be set in the processor 110. In some embodiments, at least some functional modules of the mobile communication module 150 may be set in a same device as at least some modules of the processor 110.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and then transmitted to the application processor. The application processor outputs a sound signal by using an audio device (which is not limited to the speaker 170A, the receiver 170B, or the like), or displays an image or a video by using the display 194. In some embodiments, the modem processor may be an independent device. In some other embodiments, the modem processor may be independent of the processor 110, and is set in a same device as the mobile communication module 150 or another functional module.

The wireless communication module 160 may provide a wireless communication solution that is applied to the electronic device 100 and that includes a wireless local area network (WLAN) (such as a wireless fidelity (Wi-Fi) network), Bluetooth (BT), Bluetooth low energy (BLE), an ultra-wideband (UWB), a global navigation satellite system (GNSS), frequency modulation (FM), near field communication (NFC), and an infrared (IR) technology. The wireless communication module 160 may be one or more devices integrating at least one communication processor module. The wireless communication module 160 receives an electromagnetic wave through the antenna 2, performs frequency modulation and filtering processing on an electromagnetic wave signal, and sends a processed signal to the processor 110. The wireless communication module 160 may further receive a to-be-sent signal from the processor 110, perform frequency modulation and amplification on the signal, and convert the signal into an electromagnetic wave for radiation through the antenna 2.

In some embodiments, in the electronic device 100, the antenna 1 is coupled to the mobile communication module 150, and the antenna 2 is coupled to the wireless communication module 160, so that the electronic device 100 may communicate with a network and another electronic device through a wireless communication technology. The wireless communication technology may include a global system for mobile communications (GSM), a general packet radio service (GPRS), code division multiple access (CDMA), wideband code division multiple access (WCDMA), time-division code division multiple access (TD-SCDMA), long term evolution (LTE), BT, a GNSS, a WLAN, NFC, FM, an IR technology, and/or the like. The GNSS may include a global positioning system (GPS), a global navigation satellite system (GLONASS), a BeiDou navigation satellite system (BDS), a quasi-zenith satellite system (QZSS), and/or a satellite based augmentation system (SBAS).

The electronic device 100 may implement a display function by using the GPU, the display 194, the application processor, and the like. The GPU is a microprocessor for graphics processing, and is connected to the display 194 and the application processor. The GPU is configured to: execute mathematical and geometric computation, and render an image. The processor 110 may include one or more GPUs, which execute program instructions to generate or change display information.

The display 194 is configured to display an image, a video, and the like. The display 194 includes a display panel. The display panel may be a liquid crystal display (LCD), an organic light-emitting diode (OLED), an active-matrix organic light-emitting diode (AMOLED), a flex light-emitting diode (FLED), a mini-LED, a micro-LED, a micro-OLED, a quantum dot light-emitting diode (QLED), or the like. In some embodiments, the electronic device 100 may include one or more displays 194.

The electronic device 100 may implement a photographing function by using the camera 193, the ISP, the video codec, the GPU, the display 194, the application processor (AP), the neural-network processing unit (NPU), and the like.

The camera 193 may be configured to collect color image data and depth data of a photographed object. The ISP may be configured to process the color image data collected by the camera 193. For example, during photographing, a shutter is pressed, light is transferred to a photosensitive element in the camera through a lens, an optical signal is converted into an electrical signal, and the photosensitive element in the camera transmits the electrical signal to the ISP for processing, to convert the electrical signal into an image apparent to a naked eye. The ISP may further perform algorithm optimization on noise, brightness, and complexion of the image. The ISP may further optimize parameters such as exposure and color temperature of a photographing scenario. In some embodiments, the ISP may be set in the camera 193.

In some embodiments, the camera 193 may include a color camera module and a 3D sensing module.

In some embodiments, the photosensitive element in the camera of the color camera module may be a charge coupled device (CCD) or a complementary metal-oxide-semiconductor (CMOS) photoelectric transistor. The photosensitive element converts the optical signal into the electrical signal, and then transmits the electrical signal to the ISP to convert the electrical signal into a digital image signal. The ISP outputs the digital image signal to the DSP for processing. The DSP converts the digital image signal into an image signal in a standard format such as RGB or YUV.

In some embodiments, the 3D sensing module may be a time of flight (TOF) 3D sensing module or a structured light 3D sensing module. Structured light 3D sensing is an active depth sensing technology, and basic components of the structured light 3D sensing module may include an infrared transmitter, an IR camera module, and the like. A working principle of the structured light 3D sensing module is to first transmit a light pattern in a specific shape to a photographed object, and then receive light coding on a surface of the object, to compare the light pattern with an original projected light pattern in terms of a similarity and a difference, and calculate three-dimensional coordinates of the object according to a trigonometric principle. The three-dimensional coordinates include a distance between the electronic device 100 and the photographed object. TOF 3D sensing may be the active depth sensing technology, and basic components of the TOF 3D sensing module may include the infrared transmitter, the IR camera module, and the like. A working principle of the TOF 3D sensing module is to calculate a distance (that is, a depth) between the TOF 3D sensing module and the photographed object by using an infrared refraction time, to obtain a 3D depth of field image.

The structured light 3D sensing module may be further applied to fields such as facial recognition, a somatic game console, and industrial machine vision detection. The TOF 3D sensing module may be further applied to fields such as a game console and augmented reality (AR)/virtual reality (VR).

In some other embodiments, the camera 193 may further include two or more cameras. The two or more cameras may include a color camera, and the color camera may be configured to collect the color image data of the photographed object. The two or more cameras may collect the depth data of the photographed object by using a stereo vision technology. The stereo vision technology is based on a principle of a parallax of human eyes. Under a natural light source, the two or more cameras are used to photograph an image of a same object from different angles, and then an operation such as a triangulation method is performed to obtain distance information, that is, depth information, between the electronic device 100 and the photographed object.

In some embodiments, the electronic device 100 may include one or more cameras 193. Specifically, the electronic device 100 may include one front-facing camera 193 and one rear-facing camera 193. The front-facing camera 193 may be usually configured to collect color image data and depth data of a photographer facing the display 194, and the rear-facing camera module may be configured to collect color image data and depth data of a photographed object (such as a character or a scenery) facing the photographer.

In some embodiments, a CPU, the GPU, or the NPU in the processor 110 may process the color image data and the depth data that are collected by the camera 193. In some embodiments, the NPU may identify, by using a neural network algorithm based on a skeleton point identification technology, for example, a convolutional neural network (CNN) algorithm, the color image data collected by the camera 193 (specifically, the color camera module), to determine a skeleton point of the photographed character. The CPU or the GPU may also run the neural network algorithm to determine the skeleton point of the photographed character based on the color image data. In some embodiments, the CPU, the GPU, or the NPU may be further configured to: determine a figure (for example, a body proportion and a fatness and thinness degree of a body part between skeleton points) of the photographed character based on the depth data collected by the camera 193 (which may be the 3D sensing module) and an identified skeleton point, further determine a body beautification parameter for the photographed character, and finally process a photographed image of the photographed character based on the body beautification parameter, so that a body shape of the photographed character in the photographed image is beautified. In a subsequent embodiment, how to perform body shaping processing on the image of the photographed character based on the color image data and the depth data that are collected by the camera 193 is described in detail. Details are not described herein.

The digital signal processor is configured to process a digital signal, and may further process another digital signal. For example, when the electronic device 100 selects a frequency, the digital signal processor is configured to perform Fourier transform on frequency energy.

The video codec is configured to compress or decompress a digital video. The electronic device 100 may support one or more video codecs. In this way, the electronic device 100 may play back or record videos in a plurality of coding formats, for example, moving picture experts group (MPEG)-1, MPEG-2, MPEG-3, and MPEG-4.

The NPU is a neural-network (NN) computing processor, quickly processes input information by referring to a structure of a biological neural network, for example, by referring to a mode of transmission between human brain neurons, and may further continuously perform self-learning. Applications such as intelligent cognition of the electronic device 100 may be implemented through the NPU, for example, image recognition, facial recognition, speech recognition, and text understanding.

The external memory interface 120 may be used to connect to an external storage card, for example, a micro SD card, to extend a storage capability of the electronic device 100. The external storage card communicates with the processor 110 through the external memory interface 120, to implement a data storage function. For example, files such as music and videos are stored in the external storage card. Alternatively, the files such as the music and the videos are transferred from the electronic device to the external storage card.

The internal memory 121 may be configured to store computer executable program code. The executable program code includes instructions. The internal memory 121 may include a program storage area and a data storage area. The program storage area may store an operating system, an application required by at least one function (for example, a voice playing function or an image playing function), and the like. The data storage area may store data (such as audio data and an address book) created during use of the electronic device 100, and the like. In addition, the internal memory 121 may include a high-speed random access memory, or may include a nonvolatile memory, for example, at least one magnetic disk storage device, a flash storage device, or a universal flash storage (UFS). The processor 110 runs the instructions stored in the internal memory 121 and/or the instructions stored in the memory set in the processor, to perform various function methods and data processing of the electronic device 100.

The electronic device 100 may implement an audio function, for example, music playing, recording, and the like, through the audio module 170, the speaker 170A, the receiver 170B, the microphone 170C, the headset jack 170D, and the application processor.

The audio module 170 is configured to convert digital audio information into an analog audio signal for output, and is also configured to convert an analog audio input into a digital audio signal. The audio module 170 may be further configured to code and decode an audio signal. In some embodiments, the audio module 170 may be set in the processor 110, or some functional modules in the audio module 170 are set in the processor 110.

The speaker 170A, also referred to as a “loudspeaker”, is configured to convert an audio electrical signal into a sound signal. The electronic device 100 may listen to music or output an audio signal of a hands-free call through the speaker 170A.

The receiver 170B, also referred to as an “earpiece”, is configured to convert an audio electrical signal into a sound signal. When a call is answered or speech information is received through the electronic device 100, the receiver 170B may be put close to a human ear to listen to a voice.

The microphone 170C, also referred to as a “mike” or a “mic”, is configured to convert a sound signal into an electrical signal. When making a call or sending speech information, a user may make a sound near the microphone 170C through the mouth, to input a sound signal to the microphone 170C. At least one microphone 170C may be set in the electronic device 100. In some other embodiments, two microphones 170C may be set in the electronic device 100, to collect a sound signal and implement a noise reduction function. In some other embodiments, three, four, or more microphones 170C may be further set in the electronic device 100, to collect a sound signal, reduce noise, identify a sound source, implement a directional recording function, and the like.

The headset jack 170D is configured to connect to a wired headset. The headset jack 170D may be the USB interface 130, or may be a 3.5 mm open mobile terminal platform (OMTP) standard interface or cellular telecommunications industry association of the USA (CTIA) standard interface.

The pressure sensor 180A is configured to sense a pressure signal, and may convert a pressure signal into an electrical signal. In some embodiments, the pressure sensor 180A may be set in the display 194. There is a plurality of types of pressure sensors 180A such as a resistive pressure sensor, an inductive pressure sensor, and a capacitive pressure sensor. The capacitive pressure sensor may include at least two parallel plates made of conductive materials. When a force is applied to the pressure sensor 180A, capacitance between electrodes changes. The electronic device 100 determines pressure intensity based on a change in the capacitance. When a touch operation is performed on the display 194, the electronic device 100 detects touch operation intensity by using the pressure sensor 180A. The electronic device 100 may also calculate a touch location based on a detection signal of the pressure sensor 180A. In some embodiments, touch operations that are performed on a same touch location but have different touch operation intensity may correspond to different operation instructions. For example, when a touch operation whose touch operation intensity is less than a first pressure threshold is performed on an SMS message application icon, an instruction for viewing an SMS message is executed. When a touch operation whose touch operation intensity is greater than or equal to the first pressure threshold is performed on the SMS message application icon, an instruction for creating a new SMS message is executed.

The gyroscope sensor 180B may be configured to determine a moving posture of the electronic device 100. In some embodiments, an angular velocity of the electronic device 100 around three axes (that is, axes x, y, and z) may be determined by using the gyroscope sensor 180B. The gyroscope sensor 180B may be configured to implement image stabilization during photographing. For example, when a shutter is pressed, the gyroscope sensor 180B detects an angle at which the electronic device 100 jitters, calculates, based on the angle, a distance for which a lens module needs to compensate, and controls the lens to cancel the jitter of the electronic device 100 through reverse motion, to implement the image stabilization. The gyroscope sensor 180B may also be used in a navigation scenario and a somatic game scenario.

The barometric pressure sensor 180C is configured to measure barometric pressure. In some embodiments, the electronic device 100 calculates an altitude based on a barometric pressure value measured by the barometric pressure sensor 180C, to assist in positioning and navigation.

The magnetic sensor 180D includes a Hall effect sensor. The electronic device 100 may detect opening and closing of a flip cover by using the magnetic sensor 180D. When the electronic device is a foldable electronic device, the magnetic sensor 180D may be configured to detect folding or unfolding, or a folding angle of the electronic device. In some embodiments, when the electronic device 100 is a clamshell phone, the electronic device 100 may detect opening and closing of a flip based on the magnetic sensor 180D. Further, a feature such as automatic unlocking of the flip is set based on a detected opening or closing state of the cover or a detected opening or closing state of the flip.

The acceleration sensor 180E may detect accelerations in various directions (usually on three axes) of the electronic device 100. When the electronic device 100 is still, a magnitude and a direction of gravity may be detected. The acceleration sensor 180E may be further configured to identify a posture of the electronic device, and is applied in an application such as switching between a landscape mode and a portrait mode or a pedometer.

The distance sensor 180F is configured to measure a distance. The electronic device 100 may measure the distance in an infrared manner or a laser manner. In some embodiments, in a photographing scenario, the electronic device 100 may measure the distance through the distance sensor 180F to implement quick focusing.

The optical proximity sensor 180G may include, for example, a light-emitting diode (LED) and an optical detector, for example, a photoelectric diode. The light-emitting diode may be an infrared light-emitting diode. The electronic device 100 emits infrared light through the light-emitting diode. The electronic device 100 detects infrared reflected light from a nearby object through the photoelectric diode. When intensity of the detected reflected light is greater than a threshold, it may be determined that there is an object near the electronic device 100. When the intensity of the detected reflected light is less than the threshold, the electronic device 100 may determine that there is no object near the electronic device 100. The electronic device 100 may detect, by using the optical proximity sensor 180G, that the user holds the electronic device 100 close to an ear for a call, to automatically turn off a screen for power saving. The optical proximity sensor 180G may also be used in a cover mode or a pocket mode to automatically perform screen unlocking or locking.

The ambient light sensor 180L may be configured to sense ambient light brightness. The electronic device 100 may adaptively adjust brightness of the display 194 based on sensed ambient light brightness. The ambient light sensor 180L may also be configured to automatically adjust white balance during photographing. The ambient light sensor 180L may further cooperate with the optical proximity sensor 180G to detect whether the electronic device 100 is blocked, for example, the electronic device is in a pocket. When it is detected that the electronic device is blocked or in the pocket, some functions (for example, a touch function) may be disabled to prevent a misoperation.

The fingerprint sensor 180H is configured to collect a fingerprint. The electronic device 100 may use a feature of the collected fingerprint to implement fingerprint-based unlocking, application lock accessing, fingerprint-based photographing, fingerprint-based call answering, and the like.

The temperature sensor 180J is configured to detect temperature. In some embodiments, the electronic device 100 executes a temperature processing policy through the temperature detected by the temperature sensor 180J. For example, when the temperature detected by the temperature sensor 180J exceeds a threshold, the electronic device 100 lowers performance of the processor, to reduce power consumption of the electronic device to implement thermal protection. In some other embodiments, when the temperature detected by the temperature sensor 180J is lower than another threshold, the electronic device 100 heats the battery 142. In some other embodiments, when the temperature is lower than still another threshold, the electronic device 100 may boost output voltage of the battery 142.

The touch sensor 180K is also referred to as a “touch device”. The touch sensor 180K may be set on the display 194, and the touch sensor 180K and the display 194 constitute a touchscreen, which is also referred to as a “touch interaction screen”. The touch sensor 180K is configured to detect a touch operation performed on or near the touch sensor. The touch sensor may transfer the detected touch operation to the application processor to determine a type of a touch event. A visual output related to the touch operation may be provided through the display 194. In some other embodiments, the touch sensor 180K may also be set on a surface of the electronic device 100 at a location different from that of the display 194.

The bone conduction sensor 180M may obtain a vibration signal. In some embodiments, the bone conduction sensor 180M may obtain a vibration signal of a vibration bone of a human vocal-cord part. The bone conduction sensor 180M may also be in contact with a body pulse to receive a blood pressure beating signal. In some embodiments, the bone conduction sensor 180M may also be set in the headset, to obtain a bone conduction headset. The audio module 170 may parse out a speech signal based on the vibration signal obtained by the bone conduction sensor 180M from the vibration bone of the vocal-cord part, to implement a speech function. The application processor may obtain heart rate information through parsing based on the blood pressure beating signal obtained by the bone conduction sensor 180M, to implement a heart rate detection function.

The button 190 may include a power button, a volume button, and the like. The button 190 may be a mechanical button, or may be a touch button. The electronic device 100 may receive a button input, and generate a button signal input related to a user setting and functional control of the electronic device 100.

The motor 191 may generate a vibration prompt. The motor 191 may be configured to provide an incoming call vibration prompt and a touch vibration feedback. For example, touch operations performed on different applications (for example, photographing and audio playback) may correspond to different vibration feedback effects. The motor 191 may also correspond to different vibration feedback effects for touch operations performed on different areas of the display 194. Different application scenarios (for example, a time reminder, information receiving, an alarm clock, and a game) may also correspond to different vibration feedback effects. A touch vibration feedback effect may be further customized.

The indicator 192 may be an indicator light, and may be configured to indicate a charging status and a power change, or may be configured to indicate a message, a missed call, a notification, and the like.

The SIM card interface 195 is configured to connect to a SIM card. The SIM card may be inserted into the SIM card interface 195 or removed from the SIM card interface 195, to implement contact with or separation from the electronic device 100. The electronic device 100 may support one or more SIM card interfaces. The SIM card interface 195 may support a nano-SIM card, a micro-SIM card, a SIM card, and the like. A plurality of cards may be inserted into a same SIM card interface 195 at the same time. The plurality of cards may be of a same type or different types. The SIM card interface 195 may be compatible with different types of SIM cards. The SIM card interface 195 is also compatible with the external storage card. The electronic device 100 interacts with a network through the SIM card, to implement functions such as conversation and data communication. In some embodiments, the electronic device 100 uses an eSIM, that is, an embedded SIM card. The eSIM card may be embedded into the electronic device 100, and cannot be separated from the electronic device 100.

A software system of the electronic device 100 may use a layered architecture, an event-driven architecture, a micro kernel architecture, a micro service architecture, or a cloud architecture.

In the layered architecture, software is divided into several layers, and each layer has a clear role and task. The layers communicate with each other through a software interface. In some examples, a software system of the layered architecture is divided into five layers, which are respectively an application layer, an application framework layer, runtime (RT) and a native C/C++ library, a hardware abstraction layer (HAL), and a kernel layer from top to bottom.

For example, an Android system of the layered architecture is divided into five layers, which are respectively an application layer, an application framework layer, Android runtime (ART) and a native C/C++ library, a hardware abstraction layer (HAL), and a kernel layer from top to bottom.

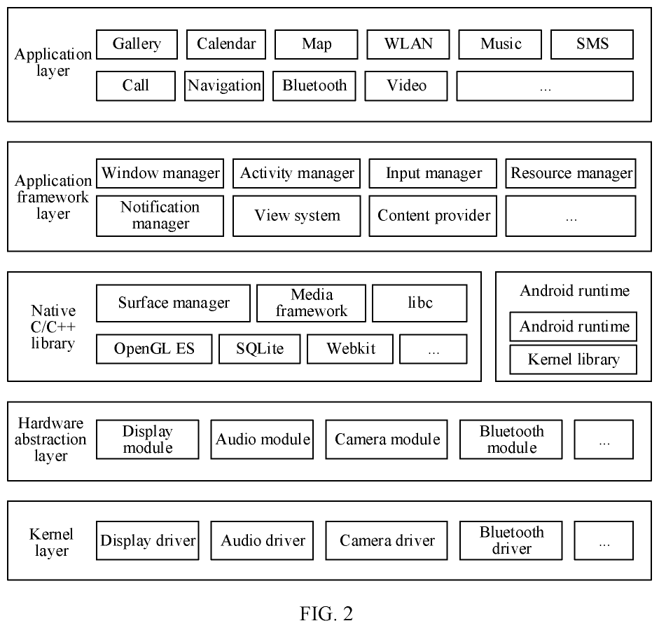

The following uses the Android system of the layered architecture as an example to describe a software structure of the electronic device 100 with reference to FIG. 2. As shown in FIG. 2, a software system of an electronic device includes an application layer, an application framework layer, a native C/C++ library, a hardware abstraction layer, and a kernel layer. The application framework layer, the native C/C++ library, the hardware abstraction layer, and the kernel layer may be collectively referred to as a system layer.

The application layer may include a series of application packages. As shown in FIG. 2, the application packages may include applications such as Camera, Gallery, Calendar, Call, Map, Navigation, WLAN, Bluetooth, Music, Video, and SMS.

The application framework layer provides an application programming interface (API) and a programming framework for an application at the application layer. The application framework layer includes some predefined functions.

As shown in FIG. 2, the application framework layer may include a window manager, a content provider, a view system, a resource manager, a notification manager, an activity manager, an input manager, and the like.

The window manager provides a window manager service (WMS). The WMS may be used for window management, window animation management, and surface management, and used as a transit station of an input system.

The content provider is used to: store and obtain data, and enable the data to be accessed by an application. The data may include a video, an image, audio, calls that are made and received, a browsing history, a bookmark, an address book, and the like.

The view system includes visual controls such as a control for displaying text and a control for displaying a picture. The view system may be used to construct an application. A display interface may include one or more views. For example, the display interface including an SMS notification icon may include a text display view and an image display view.

The resource manager provides various resources such as a localized character string, an icon, a picture, a layout file, and a video file for an application.

The notification manager enables an application to display notification information in a status bar, and may be used to convey a notification type message. The notification manager may automatically disappear after a short pause without user interaction. For example, the notification manager is used to: notify download completion, give a message notification, and the like. The notification manager may alternatively be a notification that appears in a top status bar of a system in a form of a graph or a scroll bar text, for example, a notification of an application that is run on a background, or may be a notification that appears on a screen in a form of a dialog window. For example, text information is prompted in the status bar, a prompt tone is given, the electronic device vibrates, or an indicator light blinks.

The activity manager may provide an activity manager service (AMS), and the AMS may be used to start, switch, and schedule a system component (such as an Activity, a Service, a content provider, or a broadcast receiver), and manage and schedule an application process.

The input manager may provide an input manager service (IMS). The IMS may be used to manage a system input, for example, a touchscreen input, a button input, or a sensor input. The IMS obtains an event from an input device node and allocates the event to an appropriate window by interacting with the WMS.

Android runtime includes a kernel library and Android runtime. The Android runtime is responsible for converting source code into machine code. The Android runtime mainly includes ahead or time (AOT) compiling technology and just in time (JIT) compiling technology.

The kernel library is mainly used to provide basic Java class library functions, such as libraries of a basic data structure, mathematics, an IO, a tool, a database, and a network. The kernel library provides an API for a user to develop an Android application.

The native C/C++ library may include a plurality of functional modules, for example, a surface manager, a media framework, libc, OpenGL ES, SQLite, and Webkit, and the like.

The surface manager is configured to: manage a display subsystem, and provide fusion of 2D and 3D layers for a plurality of applications. The media framework supports playback and recording of a plurality of commonly used audio and video formats, and static image files. A media library may support a plurality of audio and video coding formats, for example, MPEG-4, H.264, MP3, AAC, AMR, JPG, and PNG. The OpenGL ES provides drawing and operations of 2D and 3D graphics in an application. The SQLite provides a lightweight relational database for an application of the electronic device 100.

The hardware abstraction layer runs in a user space, encapsulates a kernel layer driver, and provides an invoking interface for an upper layer.

The kernel layer is a layer between hardware and software. The kernel layer includes at least a display driver, a camera driver, an audio driver, and a sensor driver.

In the electronic device 100 in this embodiment of this application, after an application at the application layer of the electronic device 100 is opened and a user interface of the application is displayed, there is a scenario in which a current user interface of the application is switched to another user interface. The another user interface may be referred to as a target user interface, and the scenario may be referred to as a user interface switching scenario.

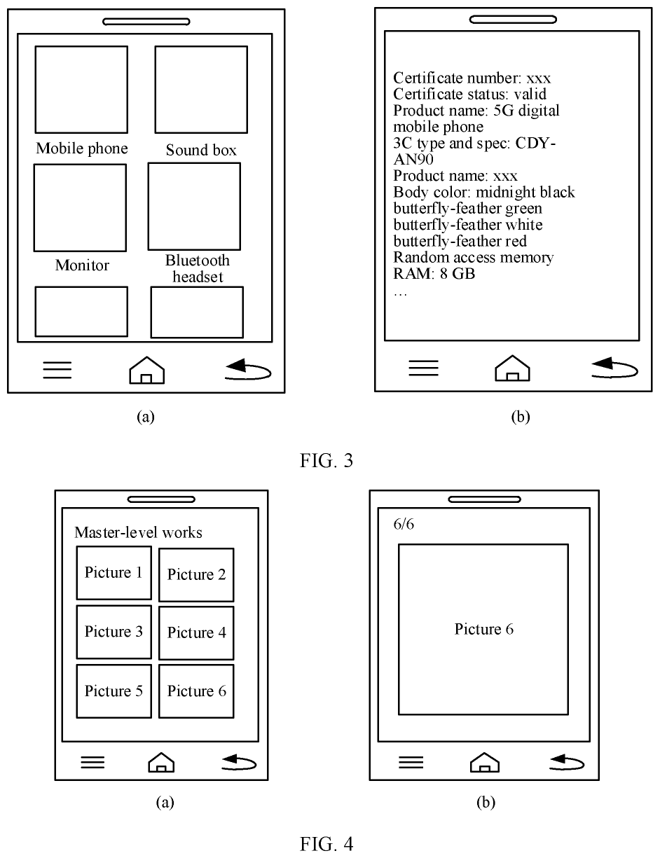

FIG. 3 is a schematic diagram of a user interface switching scenario according to an embodiment of this application. As shown in (a) in FIG. 3, an electronic device currently opens an application and displays a user interface of the application. The user interface includes brief information of a plurality of commodities such as a “mobile phone”, a “sound box”, a “monitor”, and a “Bluetooth headset”, for example, brief information such as a name, a model number, and a commodity picture.

A user inputs an instruction to the electronic device, to indicate the electronic device to switch from the current user interface to a target user interface that includes detailed commodity information of the “mobile phone”. An example of the target user interface is shown in (b) in FIG. 3.

In this embodiment, a manner in which the user inputs the instruction to the electronic device is not limited. In an example, the user may input, to the electronic device through a touchscreen of the electronic device, an instruction indicating the electronic device to switch to the target user interface. For example, the user taps a control such as a picture, an icon, or text in the current user interface, to input, to the electronic device, the instruction indicating to switch to the target user interface corresponding to these controls.

In another example, the user may input, to the electronic device through a unit such as a microphone or a headset jack of the electronic device, the instruction indicating the electronic device to switch to the target user interface.

In still another example, the user may input a gesture to the electronic device through a camera shooting unit such as a camera of the electronic device, where the gesture includes the instruction indicating the electronic device to switch to the target user interface.

When the electronic device displays the user interface shown in (a) in FIG. 3, a corresponding Activity component needs to be loaded, so that the user interacts with the electronic device through these Activity components. For example, the user interface shown in (a) in FIG. 3 includes an Activity component, and text “mobile phone” is displayed on the Activity component. In this way, when the user taps the “mobile phone”, the Activity component may notify that the application needs to switch to a user interface corresponding to detailed information of the “mobile phone”, for example, switch to the user interface shown in (b) in FIG. 3.

Similarly, when the electronic device switches from the user interface shown in (a) in FIG. 3 to the user interface shown in (b) in FIG. 3, the corresponding Activity component also needs to be loaded, so that the user interface shown in (b) in FIG. 3 includes an Activity component, and related content may be further displayed on the Activity component. In this way, when the user taps the related content, the Activity component may notify that the application needs to switch to a corresponding user interface. For example, when “ . . . ” is displayed on an Activity component, after the user taps “ . . . ”, the Activity component may notify that the application needs to switch to a user interface that includes more detailed information of the mobile phone.

FIG. 4 is a schematic diagram of a user interface switching scenario according to another embodiment of this application. As shown in (a) in FIG. 4, an electronic device currently opens an application, and displays a user interface of the application. The user interface includes one or more pictures (which may be referred to as small pictures) with low pixels. The user interface includes an Activity component, and a picture is displayed on the Activity component. In this way, when a user taps the picture, the user may indicate, through the Activity component in which the picture is located, that the application needs to switch to a large picture.

For example, after the user taps a picture 6, the electronic device may notify, through an Activity component in which the picture 6 is located, the application to switch to a high-pixel picture (which may be referred to as a large picture) corresponding to the picture 6. A user interface used to display the high-pixel picture is referred to as a target user interface. An example of the target user interface is shown in (b) in FIG. 4.

When the electronic device displays the user interface shown in (b) in FIG. 4, a new service often needs to be started, and the user interface is displayed by using the service. In this way, when the electronic device displays the user interface shown in (b) in FIG. 4, related content of the user interface shown in (a) in FIG. 4 does not need to be deleted.

The user interface shown in (b) in FIG. 4 needs to include an Activity component, and the large picture is displayed on the Activity component. In this way, when the user taps the large picture, the Activity component may notify the application to exit displaying of the large picture and display a previous user interface.

In this embodiment, for a manner in which the user inputs an instruction to the electronic device, refer to related content in the embodiment shown in FIG. 3. Details are not described herein again.

In the conventional technology, when the electronic device switches from a current user interface of the application to the target user interface, to be specific, after the user inputs, to the electronic device, an instruction indicating the electronic device to switch from the current user interface to the target user interface, the electronic device loads an Activity component corresponding to the target user interface, and an operation of loading the Activity component by the electronic device is performed in serial with another operation performed by the electronic device for switching to the target user interface. Consequently, the user interface switching of the electronic device is time-consuming, that is, switching efficiency is low.

In addition, in the conventional technology, in some scenarios in which the electronic device switches from the current user interface to the target user interface, for example, in the scenario shown in FIG. 4, the electronic device needs to start a service related to user interface switching. Because an operation of starting a process required for the service is performed in serial with another operation, user interface switching is further time-consuming, that is, the switching efficiency is lower.

For the foregoing problem, this application provides a new technical solution of user interface switching. In the technical solution proposed in this application, before the Activity component corresponding to the target user interface of the application needs to be used, when a UI thread of the application runs, another parallel thread is used to load the Activity component, to resolve a problem that serial loading of the Activity component is time-consuming, so that user interface switching efficiency can be improved, a frame loss rate in a user interface switching process can be reduced, and system performance can be further improved.

In this application, when the UI thread of the application runs, the Activity component is loaded by using the another parallel thread, which may be referred to as parallel loading of the Activity component for short.

In this application, that the another thread for loading the Activity component is parallel to the UI thread may be understood as: A time period in which the Activity component is loaded by using the another thread completely or partially overlaps a life cycle of the UI thread.

For example, when the UI thread starts to run, the another thread starts to run to load the Activity component. For another example, after the UI thread starts to run, the another thread starts to run to load the Activity component.

In the technical solution of this application, optionally, the Activity component that is loaded in parallel may be an Activity component that has long loading duration. Which Activity components are Activity components that have long loading duration may be determined based on a requirement. For example, an Activity component whose loading duration is greater than or equal to 150 milliseconds (ms) may be defined as the Activity component that has long loading duration.

In the technical solution proposed in this application, optionally, Activity components may be loaded in parallel in a plurality of phases, to resolve a problem of insufficient time windows in a single phase. In an example, an Activity class corresponding to the target user interface may be loaded in parallel in a main process starting phase of the application. For example, when loading of a main process of the application is completed, the Activity class corresponding to the target user interface is loaded in parallel; and then an empty Activity instance corresponding to the Activity class is loaded in parallel in a user interface switching phase. The user interface switching phase may be understood as a phase starting from a moment at which a system layer of the electronic device receives a user interface switching instruction.

Optionally, when an actual Activity instance corresponding to the target user interface needs to be created based on an empty Activity instance corresponding to the target user interface, it may be first determined whether the empty Activity instance corresponding to the target user interface already exists in a cache. If the empty Activity instance exists, the actual Activity instance corresponding to the target user interface may be directly created based on the empty Activity instance. Otherwise, the actual Activity instance corresponding to the target user interface may be created based on the empty Activity instance.

Furthermore, in the technical solution of this application, when the UI thread of the application runs, another process (a process different from the main process of the application) on which displaying of the target user interface depends may be loaded by using a thread that runs in parallel with the UI thread, to resolve a problem that serial loading of the another process is time-consuming, so that the user interface switching efficiency can be improved, the frame loss rate in the user interface switching process can be reduced, and the system performance can be further improved.

In this technical solution, when the UI thread of the application runs, the another process on which the displaying of the target user interface depends is loaded by using the thread that runs in parallel with the UI thread, which may be referred to as parallel loading of the another process for short.

In some implementations of the technical solution, the process on which the displaying of the target user interface depends is usually implemented by using a corresponding Service component to implement a corresponding service to display the target user interface, in a process of loading the Service component, whether a process used to run the Service component exists is detected, and when the process used to run the Service component does not exist, the process is automatically created and the Service component is loaded in the created process. Therefore, the another process on which the displaying of the target user interface depends may be loaded in parallel by using a following manner: using the thread that runs in parallel with the UI thread of the application to load the Service component.

In the technical solution of this application, the parallel loading of the Activity component and parallel loading of the process, or the parallel loading of the Activity component and parallel loading of the Service component may be performed in parallel, or may be performed in serial based on a sequence.

It may be understood that when the parallel loading of the Activity component and the parallel loading of the process (or the Service component) are performed in serial based on a sequence, the sequence of loading the Activity component and the process (or the Service component) is not limited in this application. In addition, a thread for loading the Activity component in parallel and a thread for asynchronously loading the process (the Service component) may be a same thread, or may be different threads.

In the technical solution of this application, optionally, a parallel loading process may be a process that has long loading duration. Which processes are processes that have long loading duration may be determined based on a requirement. For example, a process whose loading duration is greater than or equal to 150 milliseconds (ms) may be defined as the process that has long loading duration.

In the method in each embodiment of this application, loading duration of each component in a component library may be first tested. The component library includes the Activity component and the Service component. Loading duration of the Service component may include duration of starting the process used to run the Service component.

After the loading duration of the component in the component library is obtained through testing, a component whose loading duration is greater than or equal to a preset duration threshold (for example, 150 milliseconds) in the component library may be denoted as a static component, and another component is denoted as a dynamic component.

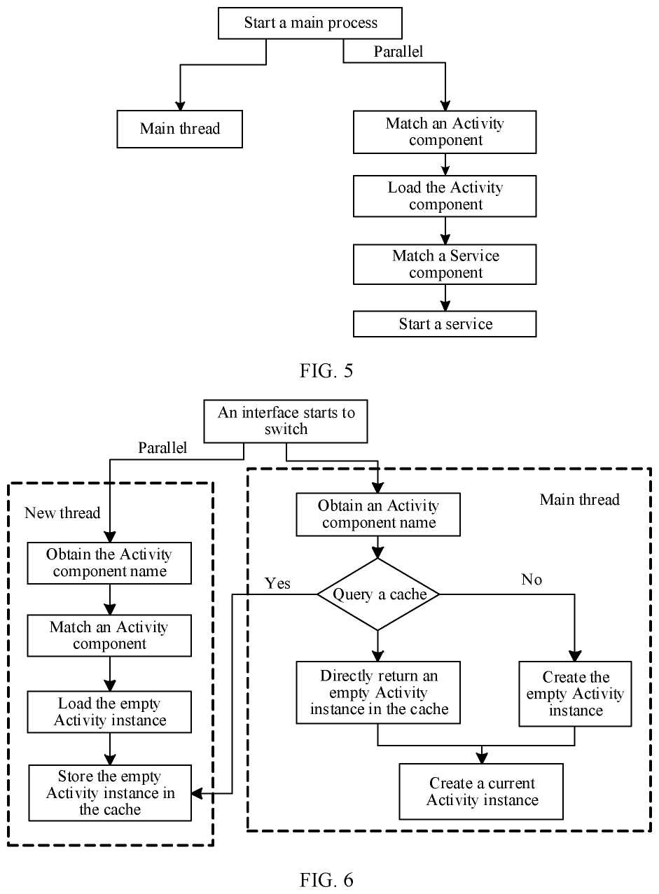

The following describes a user interface switching method according to an embodiment of this application with reference to FIG. 5. The method may be performed by a system layer of an electronic device.

After a main process of an application shown in FIG. 5 starts, component library matching is performed on a component in the application, where the component library matching is asynchronous, that is, parallel to starting of the main process of the application.

In an example, the main process is a process used to cold start the application from a desktop. For example, if a user taps an application icon on the desktop of the electronic device, the main process of the application starts.

Generally, a name of the main process of the application is usually consistent with a package name of the application. For example, a main process of a “Jingdong®” application is “com.jingdong.app.mall”, and another process is a subprocess such as “com.ingdong.app.mall:jdpush” or “com.jingdong.app.mall:WatchDogService”.

After the component library matching is performed on the component in the application, if a static component matching an Activity component of the application exists in the component library, an Activity class corresponding to the matched Activity component is loaded. Loading of the Activity class corresponding to the matched Activity component runs in parallel with a UI thread of the application. For example, a new thread is created, and the Activity class corresponding to the matched Activity component is loaded in the thread, and the new thread runs in parallel with the UI thread of the application.

The “Jingdong®” application is used as an example. During a main process “com.jingdong.app.mall” starting phase, “com.jd.lib.productdetail.ProductDetailActivity” is loaded in parallel to a virtual machine. For example, context information of the “Jingdong®” application is obtained, where the context information may include basic information such as an application package name of the “Jingdong®” application; a corresponding class loader “ClassLoader” is obtained, a thread parallel to a UI thread of the “Jingdong®” application starts, and “com.jd.lib.productdetail.ProductDetailActivity” is loaded to the virtual machine by using the class loader in the thread.

After loading of the class corresponding to the matched Activity component is completed, if a static component matching a Service component of the application exists in the component library, the matched Service component is loaded in parallel. An operation of loading the matched Service component runs in parallel with the UI thread of the application. For example, a new thread is created, and the matched Service component is loaded based on the thread, and the new thread runs in parallel with the UI thread of the application. It may be understood that the loading of the matched Service component may include starting a process corresponding to the Service component, and loading a Service class corresponding to the Service component in the process.

A “Sina Weibo®” application is used as an example. During a main process “com.sina.weibo” starting phase, “ImageViewerService” Service starts asynchronously.

After the application is started, the electronic device displays a user interface of the application. For example, when the application is “Jingdong®”, an example of a displayed user interface is shown in (a) in FIG. 3. For another example, when the application is “Sina Weibo®”, an example of a displayed user interface is shown in (a) in FIG. 4.

After the user inputs a user interface switching instruction on a user interface currently displayed by the electronic device, for example, after the user taps object details shown in (a) in FIG. 3 or the user taps a picture in (a) in FIG. 4, the electronic device starts a UI thread of the user interface.

After the UI thread starts, the electronic device may learn of information such as an Activity component name corresponding to a target user interface, and then perform Activity component matching. The Activity component matching is parallel to the UI thread of the application.

If a static component matching the Activity component corresponding to the target user interface exists in the component library, an empty Activity instance is created based on the previously loaded Activity class, and the empty Activity instance is stored, where creation of the empty Activity instance is performed in parallel with the UI thread of the application. For example, a new thread is created, the empty Activity instance is created in the thread based on the Activity class, and the thread is in parallel with the UI thread of the application.

As shown in FIG. 6, in a user interface switching process, when an actual Activity instance corresponding to a target user interface needs to be created, a storage space (for example, a cache) is first queried for whether there is a corresponding empty Activity instance. If there is the corresponding empty Activity instance, the empty Activity instance is directly read, and the actual Activity instance is created based on the empty Activity instance; or if there is no corresponding empty Activity instance, an Activity class corresponding to the target user interface is loaded, the empty Activity instance is created based on the Activity class, and the actual Activity instance is created based on the empty Activity instance.

An understanding manner of the actual Activity instance in this embodiment is: an Activity instance that includes target user interface information, for example, an Activity instance that includes layout information, type information, color information, resource information, or the like of each page element in the target user interface.

In this embodiment, if displaying of the target user interface further requires a corresponding Service, the Service may directly start in a previously created process based on a loaded Service class.

For example, when a user taps a small picture in a “Sina Weibo®” application to switch to a corresponding large picture, an “ImageViewerService” service that has started in parallel in a main process starting phase of the “Sina Weibo®” application may be directly used.

After an Activity instance required for the target user interface is created and a task related to a UI thread is executed, an electronic device may display the target user interface. The target user interface may include a related Activity component. An example of the target user interface is shown in (b) in FIG. 3 or (b) in FIG. 4.

In this embodiment, because loading of the Activity class, creation of the empty Activity instance, creation of the process corresponding to the Service class, and creation of the Service class are all completed in parallel with the UI thread of the application, that the Activity class is time-consuming when loaded and the empty Activity instance is time-consuming when created can be avoided, so that user interface switching efficiency can be improved.

In addition, the loading of the Activity class and the creation of the empty Activity instance are completed in different phases. This can avoid a problem of insufficient available duration in a same phase, so that the user interface switching efficiency can be further ensured.

It may be understood that the embodiment shown in FIG. 5 or FIG. 6 is merely an example of the user interface switching method provided in this application. The user interface switching method provided in this application may further include more or fewer steps.

For example, in another example, the parallel loading of the Service component may not be limited to the main process starting phase of the application. For example, for loading of the Service component, refer to the conventional technology. Serial loading is performed in a user interface switching phase, or parallel loading is performed in the user interface switching phase.

In a third example, the parallel loading of the Service component may be performed before parallel loading of an Activity component, or the parallel loading of the Service component and the parallel loading of the Activity component may be performed in parallel.

In a fourth example, the loading of the Activity class and the creation of the empty Activity instance are not limited to the different phases, but are both located in the user interface switching phase.

In a fifth example, parallel starting of the process corresponding to the Service component and loading of the Service class in the process are not limited to being completed in a same phase. For example, the process corresponding to the Service component may start in parallel in the main process starting phase of the application, and then the Service class is loaded (in parallel or in serial) in the process in the user interface switching phase.

In a sixth example, parallel loading of a component may start only after the Activity component matching is successful, to be specific, if there is a static component in the application.

In a seventh example, parallel creation of the empty Activity instance may start only when an Activity component name is obtained and the Activity component matching is performed successfully based on the Activity component name, that is, if there is a static component in the application.

In an eighth example, the Activity component matching may start in parallel based on the Activity component name only after the Activity component name is obtained.

The following describes an embodiment of loading a component in this application. For example, after the user taps the application icon on the desktop of the electronic device, a desktop application of the electronic device receives an instruction input by the user for starting the application, and sends, to the system layer of the electronic device, a request for starting the application. After receiving the request, the system layer of the electronic device performs the main process starting phase of the application, and performs a parallel loading procedure of the component.

A user interface switching scenario is used as an example. The system layer of the electronic device loads in parallel, in the main process starting phase of the application, a class file corresponding to the Activity component, and may further load the Service component to start the service.

An example of a displayed user interface after the application starts is shown in (a) in FIG. 3. The user interface displayed by the application may include one or more Activity components, and information such as text, a picture, or a link is displayed on the Activity component. When the user taps the information in the user interface, an Activity component in which the information is located may receive an instruction input by the user. After the Activity component receives the instruction input by the user, the application sends, to the system layer, a request to switch to the target user interface indicated by the Activity component.

After receiving the request, the system layer enters the user interface switching phase, and performs a parallel creation procedure of an empty instance. Generally, Activity components that need to be included in the target user interface indicated by each Activity component in the user interface are preset. Therefore, after the user taps the Activity component, the application may learn of the Activity components that need to be included in the target user interface, to learn of instances corresponding to the Activity components that need to be created, and/or may learn whether the target user interface needs to be displayed by using a service and learn of services that need to be used to display the target user interface.

It may be understood that the foregoing embodiment is described by using loading of the Activity component and the Service component in the user interface switching scenario as an example. However, a method for loading the component provided in this application is not limited to the user interface switching scenario, and is not limited to the loading of the Activity component and the Service component. Any technical solution of loading a component corresponding to an application in parallel outside a UI thread of the application shall fall within the protection scope of this application.

It may be understood that, to implement the foregoing functions, a first device and a second device include corresponding hardware and/or software modules to perform the functions. In combination with example algorithm steps described in embodiments disclosed in this specification, this application may be implemented by hardware or a combination of hardware and computer software.

Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments, the electronic device may be divided into functional modules based on the foregoing method examples. For example, each functional module corresponding to each function may be obtained through division, or two or more functions may be integrated into one processing module. The integrated module may be implemented in a form of hardware. It should be noted that, in embodiments, division into the modules is an example, is merely logical function division, and may be other division during actual implementation.

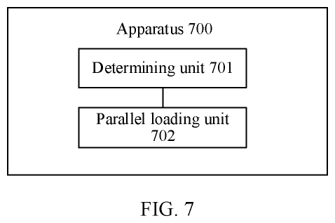

When each functional module is obtained through division based on each corresponding function, FIG. 7 is a schematic diagram of a possible composition of an apparatus 700 for loading a component related to the foregoing embodiments. As shown in FIG. 7, the apparatus 700 for loading the component may include a determining unit 701 and a parallel loading unit 702.

The apparatus 700 may be configured to implement any one of the foregoing method embodiments. For example, the determining unit 701 is configured to run a first thread of an application, where the first thread is a user interface UI thread of the application; and the parallel loading unit 702 is configured to load the component of the application based on a second thread, where the second thread runs in parallel with the first thread.

Optionally, the component includes an Activity component and/or a Service component.

When the component includes the Activity component, the parallel loading unit may be specifically configured to: load, in a main process starting phase of the application by using the second thread, a class file corresponding to the Activity component; and create an empty instance in a user interface switching phase of the application based on the class file by using a third thread, where the user interface switching phase is a phase starting from inputting a user interface switching instruction by a user.

Before the empty instance is created in the user interface switching phase of the application based on the class file by using the third thread, the apparatus further includes a receiving module. The module is specifically configured to receive the user interface switching instruction input by the user in a first user interface of the application, where the user interface switching instruction instructs to switch to a second user interface, and the second user interface includes detailed information about first information described by a first control in the first user interface.

After the empty instance is created in the user interface switching phase of the application based on the class file by using the third thread, the apparatus further includes a display module. The module is specifically configured to display the second user interface based on the instance.

When the component includes the Service component, the parallel loading unit may be specifically configured to load the Service component in the main process starting phase of the application by using the second thread. The receiving module is further configured to receive the user interface switching instruction input by the user in a third user interface of the application, where the user interface switching instruction instructs to switch to a fourth user interface, the third user interface includes a first picture, the fourth user interface includes a second picture, the second picture and the first picture include same content, and a pixel of the second picture is higher than a pixel of the first picture; and the display module is further configured to display the fourth user interface based on a service corresponding to the Service component.

Optionally, the component includes a component whose loading duration is greater than or equal to a preset duration threshold.

It should be noted that all related content of the steps in the foregoing method embodiments may be cited in function descriptions of corresponding functional modules. Details are not described herein again.

An electronic device provided in an embodiment is configured to perform the method performed by the first device or a sharing party in the foregoing method embodiments, or is configured to perform the method performed by the second device or a shared party in the foregoing method embodiments. Therefore, a same effect as the foregoing implementation methods can be reached.

In a case of an integrated unit, the apparatus may include a processing module, a storage module, and a communication module. The processing module may be configured to control and manage an action of the electronic device, for example, may be configured to support the electronic device in performing the steps performed by the determining unit 701 and the parallel loading unit 702. The storage module may be configured to support the electronic device in storing program code, data, and the like. The communication module may be configured to support communication between the electronic device and another device.

The processing module may be a processor or a controller. The processing module may implement or execute various example logical blocks, modules, and circuits described with reference to content disclosed in this application. The processor may alternatively be a combination for implementing a computing function, for example, a combination including one or more microprocessors or a combination of a digital signal processor (DSP) and a microprocessor. The storage module may be a memory. The communication module may be specifically a device, for example, a radio frequency circuit, a Bluetooth chip, a Wi-Fi chip, or the like that interacts with another electronic device.

In an embodiment, when the processing module is the processor and the storage module is the memory, the apparatus in this embodiment may be a device having the structure shown in FIG. 1.

An embodiment further provides a computer storage medium. The computer storage medium stores computer instructions. When the computer instructions are run on an electronic device, the electronic device is enabled to perform the related method steps, to implement the method in the foregoing embodiments.

An embodiment further provides a computer program product. When the computer program product is run on a computer, the computer is enabled to perform the related steps, to implement the method in the foregoing embodiments.

In addition, an embodiment of this application further provides an apparatus. The apparatus may be specifically a chip, a component, or a module. The apparatus may include a processor and a memory that are connected. The memory is configured to store computer-executable instructions. When the apparatus runs, the processor may execute the computer-executable instructions stored in the memory, to enable the chip to perform the method in the foregoing method embodiments.

The electronic device, the computer storage medium, the computer program product, or the chip provided in embodiments is configured to perform the corresponding method provided above. Therefore, for beneficial effects that can be achieved, refer to the beneficial effects of the corresponding method provided above. Details are not described herein again.

Based on descriptions about the foregoing implementations, a person skilled in the art may understand that, for a purpose of convenient and brief description, division into the foregoing functional modules is used as an example for illustration. In actual application, the foregoing functions may be allocated to different functional modules and implemented based on a requirement. In other words, an inner structure of the apparatus is divided into different functional modules to implement all or some of the functions described above.

In the several embodiments provided in this application, it should be understood that the disclosed apparatus and method may be implemented in other manners. For example, the described apparatus embodiment is merely an example. For example, division into the modules or units is merely logical function division and may be other division in actual implementation. For example, a plurality of units or components may be combined or integrated into another apparatus, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may be one or more physical units, may be located in one place, or may be distributed on different places. Some or all of the units may be selected based on actual requirements to achieve the objectives of the solutions of embodiments.

In addition, each functional unit in embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a readable storage medium. Based on such an understanding, the technical solutions of embodiments of this application essentially, or the part contributing to the conventional technology, or all or some of the technical solutions may be implemented in the form of a software product. The software product is stored in a storage medium and includes several instructions for instructing a device (which may be a single-chip microcomputer, a chip, or the like) or a processor to perform all or some of the steps of the methods in embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art in the technical scope disclosed in this application shall fall within the protection scope of this application. Therefore, the protection scope of this application shall be subject to the protection scope of the claims.

What is claimed is:

1. A method, comprising:
running, by an electronic device, a first thread of an application, wherein the first thread is a user interface (UI) thread of the application; and
loading, by the electronic device, a component of the application based on a second thread, wherein the second thread runs in parallel with the first thread.

2. The method according to claim 1, wherein when the component comprises an activity component, loading the component of the application based on the second thread comprises:
loading, by the electronic device in a main process starting phase of the application, a class file corresponding to the activity component by using the second thread; and
creating, by the electronic device, an empty instance in a UI switching phase of the application based on the class file by using a third thread, wherein the UI switching phase starts from inputting a UI switching instruction by a user.

3. The method according to claim 2, wherein before creating the empty instance in the UI switching phase of the application based on the class file by using the third thread, the method further comprises:
receiving, by the electronic device, the UI switching instruction input by the user in a first UI of the application, wherein the UI switching instruction instructs to switch to a second UI, and the second UI comprises first information described by a first control in the first UI; and
after creating the empty instance in the UI switching phase of the application based on the class file by using the third thread, the method further comprises:
displaying, by the electronic device, the second UI based on the empty instance.

4. The method according to claim 1, wherein when the component comprises a service component, loading the component of the application based on the second thread comprises:
loading, by the electronic device, the service component in a main process starting phase of the application by using the second thread.

5. The method according to claim 4, wherein the method further comprises:
receiving, by the electronic device, a UI switching instruction input by a user in a third UI of the application, wherein the UI switching instruction instructs to switch to a fourth UI, the third UI comprises a first picture, the fourth UI comprises a second picture, the second picture and the first picture comprise same content, and a pixel of the second picture is higher than a pixel of the first picture; and
displaying, by the electronic device, the fourth UI based on a service corresponding to the service component.

6. The method according to claim 1, wherein the component comprises a component whose loading duration is greater than or equal to a preset duration threshold.

7. An apparatus, comprising:
at least one processor; and
at least one memory coupled to the at least one processor and storing program instructions for execution by the at least one processor to:
run a first thread of an application, wherein the first thread is a user interface (UI) thread of the application; and
load a component of the application based on a second thread, wherein the second thread runs in parallel with the first thread.

8. The apparatus according to claim 7, wherein when the component comprises an activity component, the program instructions are for execution by the at least one processor to:
load, in a main process starting phase of the application by using the second thread, a class file corresponding to the activity component; and
create an empty instance in a UI switching phase of the application based on the class file by using a third thread, wherein the UI switching phase starts from inputting a UI switching instruction by a user.

9. The apparatus according to claim 8, wherein the program instructions are for execution by the at least one processor to:
receive the UI switching instruction input by the user in a first UI of the application, wherein the UI switching instruction instructs to switch to a second UI, and the second UI comprises first information described by a first control in the first UI; and
after the empty instance is created in the UI switching phase of the application based on the class file by using the third thread, display the second UI based on the empty instance.

10. The apparatus according to claim 7, wherein when the component comprises a service component, the program instructions are for execution by the at least one processor to:
load the service component in a main process starting phase of the application by using the second thread.

11. The apparatus according to claim 10, wherein the program instructions are for execution by the at least one processor to:
receive the a UI switching instruction input by a user in a third UI of the application, wherein the UI switching instruction instructs to switch to a fourth UI, the third UI comprises a first picture, the fourth UI comprises a second picture, the second picture and the first picture comprise same content, and a pixel of the second picture is higher than a pixel of the first picture; and
display the fourth UI based on a service corresponding to the service component.

12. The apparatus according to claim 7, wherein the component comprises a component whose loading duration is greater than or equal to a preset duration threshold.

13. A non-transitory computer-readable medium comprising program instructions which, when executed by at least one processor, cause the at least one processor to perform operations comprising:
running a first thread of an application, wherein the first thread is a user interface (UI) thread of the application; and
loading a component of the application based on a second thread, wherein the second thread runs in parallel with the first thread.

14. The non-transitory computer-readable medium according to claim 13, when the component comprises an activity component, the operations comprising:
loading, in a main process starting phase of the application by using the second thread, a class file corresponding to the activity component; and
creating an empty instance in a UI switching phase of the application based on the class file by using a third thread, wherein the UI switching phase starts from inputting a UI switching instruction by a user.

15. The non-transitory computer-readable medium according to claim 14, wherein the operations comprising:
receiving the UI switching instruction input by the user in a first UI of the application, wherein the UI switching instruction instructs to switch to a second UI, and the second UI comprises first information described by a first control in the first UI; and
after the empty instance is created in the UI switching phase of the application based on the class file by using the third thread, displaying the second UI based on the empty instance.

16. The non-transitory computer-readable medium according to claim 13, wherein when the component comprises a service component, the operations comprising:
loading the service component in a main process starting phase of the application by using the second thread.

17. The non-transitory computer-readable medium according to claim 16, wherein the operations comprising:
receiving a UI switching instruction input by a user in a third UI of the application, wherein the UI switching instruction instructs to switch to a fourth UI, the third UI comprises a first picture, the fourth UI comprises a second picture, the second picture and the first picture comprise same content, and a pixel of the second picture is higher than a pixel of the first picture; and
displaying the fourth UI based on a service corresponding to the Service component.

18. The non-transitory computer-readable medium according to claim 13, wherein the component comprises a component whose loading duration is greater than or equal to a preset duration threshold.
